(19) United States
(12) Patent Application Publication
(10) Pub. No.: US 2009/0183638 A1
(43) Pub. Date: Jul. 23, 2009

(54) Wooden bottle for ageing liquids

(76) Inventor: Sastry K. Ganti, Buffalo Grove, IL (US)

Correspondence Address: SASTRY K GANTI, 1074 CROFTON LANE, BUFFALO GROVE, IL, 60089-4114, US

(21) Appl. No.: 12/009,794

(22) Filed: Jan. 23, 2008

(51) Int. Cl. C12H 1/22; B65D 41/02

(52) U.S. Cl. 99/277; 215/316

(57) ABSTRACT

A wooden bottle of suitable size for sale in stores and with interior walls flame treated, is filled directly with liquor to be aged and subsequently marketed at retail, thus eliminating the need for barrels and glass bottles.

### CROSS-REFERENCE TO RELATED APPLICATION

Not applicable

### FEDERALLY SPONSORED RESEARCH

Not applicable

### SEQUENCE LISTING OR PROGRAM

Not Applicable

### BACKGROUND OF THE INVENTION

1. Field of Invention

This invention relates to a wooden bottle designed and sized for retail sale. Its interior is heat treated with flame, to prepare it to age liquids such as whiskey and wine. The size and shape of the bottle is such that it can be displayed and sold more conveniently at retail than the traditional glass bottle. The content continues to age from the moment the bottle is filled until it is emptied. The wooden bottle will make unnecessary the requirement of aging liquors in barrels and subsequent transfer to glass bottles.

2. Prior Art

With prior art:
the need for manufacturing and handling of large barrels and glass bottles for retail adds cost to the price of liquor,
the transfer of liquor into glass bottles has to wait until the aging process is complete,
once the liquor is transferred into glass bottles, the aging process is arrested,
the vulnerability of glass to breakage requires special attention to handling of bottles at all stages,
the vulnerability of glass to breakage makes stacking of bottles impractical at all stages,
the vulnerability of glass to breakage necessitates added cushioning mediums, such as cardboard, to separate adjacent bottles from bumping during shipping,
glass bottles are inherently not biodegradable, unfriendly to environment,
glass bottles are not machinable with machine tools in the traditional sense,
the fluid contact area to fluid volume ratio for a barrel being much smaller when the same is compared to similar ratio for a bottle, the fluid particles are presented with a worse aging condition when compared to a bottle,
the distances of particle travel in a barrel to contact barrel walls being greater in a barrel as compared to a bottle, the fluid will take longer to age when same conditions are compared to a bottle;

### BACKGROUND OF THE INVENTION, OBJECTS AND ADVANTAGES

The advantages of the present invention are:
by directly filling a wooden bottle of retail sale with liquor to age, the need of barrel is eliminated,
the need for a glass bottle and all its stated disadvantages are eliminated,
the aging of liquor can continue at all times until the consumer decides to empty the bottle due to consumption,
the manufacturer of liquor may sell partially aged liquor to the retailer at discount, thus reducing warehouse inventory,
the retailer may sell partially aged liquor to the consumer at discount, thus reducing store inventory,
the consumer has the option of opening the bottle prior to full aging for consumption at any time as desired,
the wooden bottles may be returned for reuse,
for reasons elaborated in prior section on limitations of prior art, the liquor ages quicker and superior aging environment exists in a bottle,
more liquor volume may be shipped in a given space with wooden bottles, since they can be stacked adjacent to each other in direct contact, either vertically or horizontally.

### SUMMARY

In accordance to the presented invention, the use of a wooden bottle, designed and sized for sale at retail, will have beneficial effects on:
the aging of liquor,
the shipping and handling of liquor,
the pricing of liquor,
the environment; and
the options available to the manufacturer, retailer, and consumer.

Barrels for aging and glass bottles for retailing will not be needed.

### DRAWINGS, FIGURES

FIG. 1 Square shaped wooden bottle, to age liquor and sized for retailing

FIG. 2 Cutaway view of bottle near top, through screwed cap

FIG. 3 Underside view of top end piece of bottle

FIG. 4 See-through screw on filler cap at top end piece

FIG. 5 Bottle with, a see-through embedded button on side and opaque cap

FIG. 6 Bottle whose cap is replaced with a dispensing spout

FIG. 7 Rectangle shaped wooden bottle with top end piece removed

FIG. 7 Circle shaped wooden bottle with top end piece removed

FIG. 8 Ellipse shaped wooden bottle with top end piece removed

FIG. 10 Hexagon shaped wooden bottle with top end piece removed

FIG. 11 Wooden bottle whose inside surfaces are being flame treated

FIG. 12 Bottles stacked vertically

FIG. 13 Bottles stacked horizontally

FIG. 14 Bottle's body made of individual pieces for sides and bottom

### DRAWINGS, REFERENCE NUMERALS

20 Bottle's body hollowed out of a single piece of wood

22 Bottle's top end piece

24 Screwed on see-through type cap

26 See-through type button

28 Cutaway view of bottle with embedded see-through type button

30 Screwed-on opaque cap

32 Dispensing spout

34 Flame nozzle with flame

### Description and Operation of Preferred Embodiment

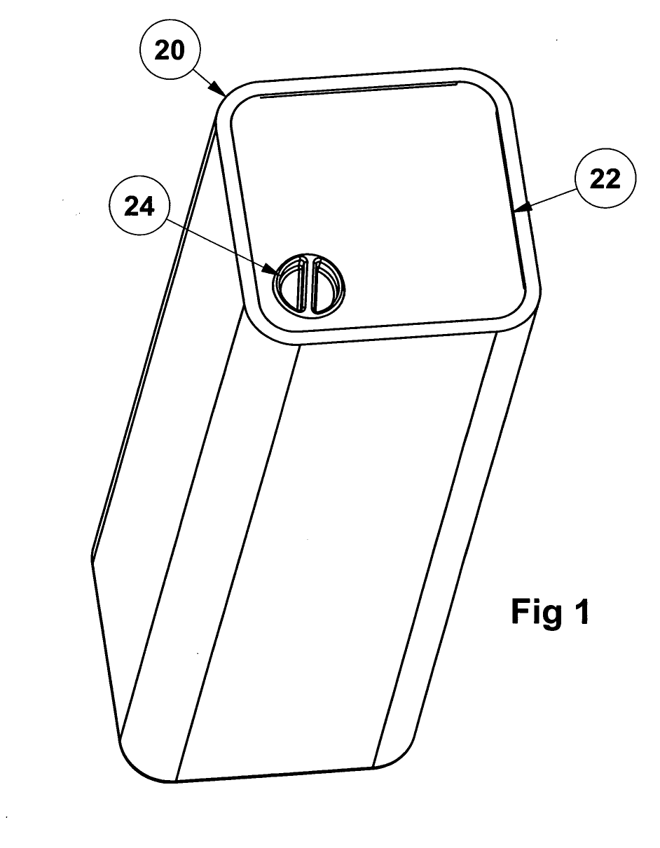

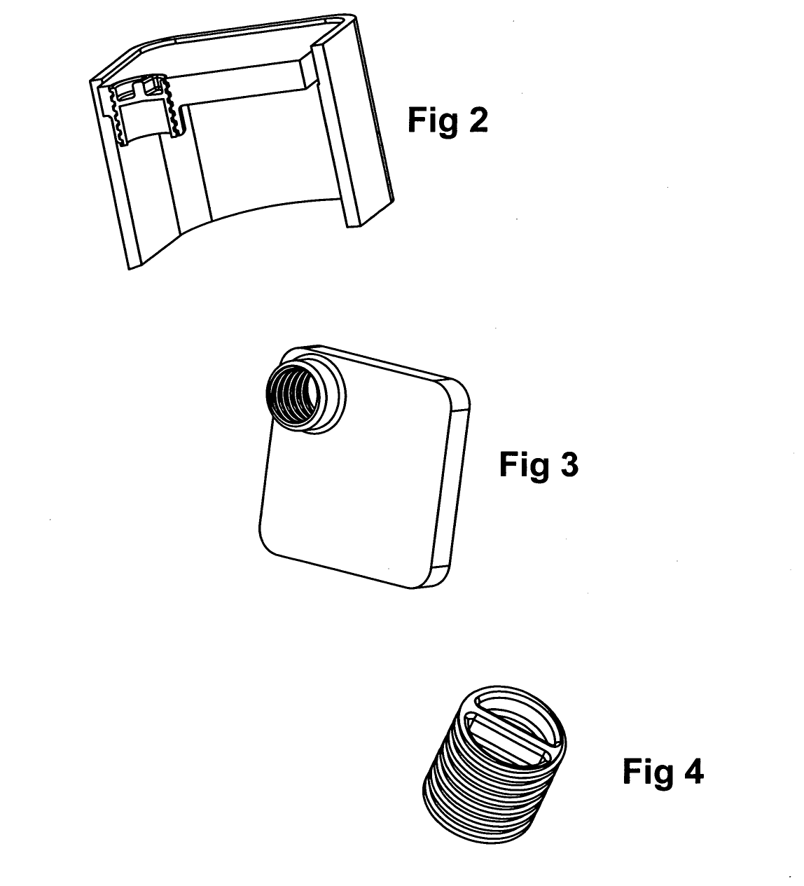

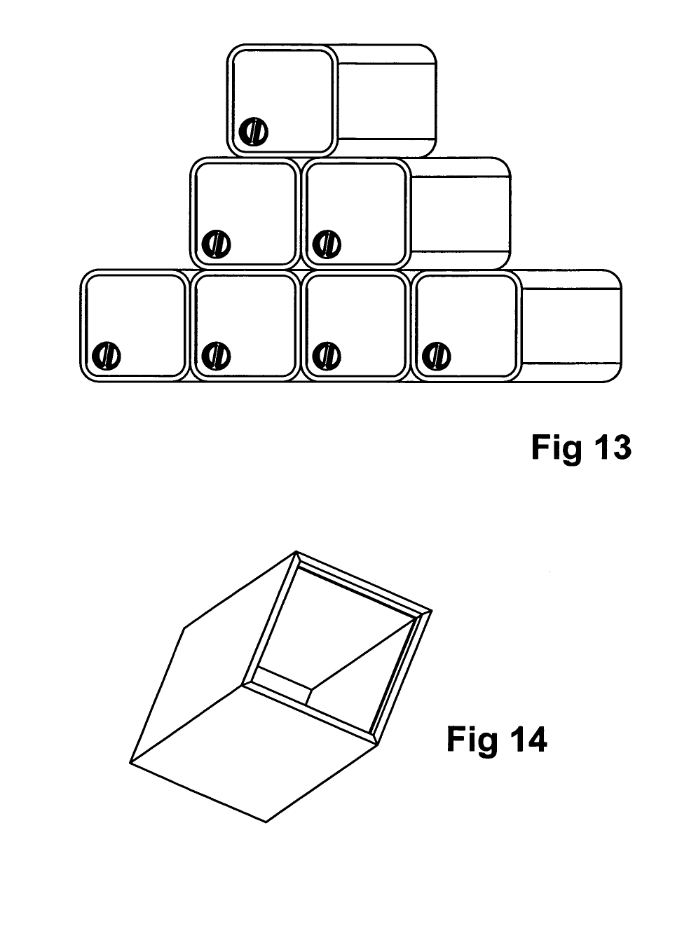

The preferred embodiment of a wooden bottle for aging liquids is square shaped as shown in FIG. 1. Its body is carved out by machining a single block of sawed wood to form its sides and bottom. The open topside's inside rim edges are more precisely machined to receive the top end piece, #22. All the inside surfaces of the body are flame heat treated in preparation to age suitable liquids such as whiskey, FIG. 11 and #34. Other treatments may be applied to the bottle as required by different processes. The top end piece, #22, is precision machined to be pressed into the bottle's body. It is also machined to receive a screw-on see-through cap, #24. One will be able to judge the aging of bottle's content, not only by the lapse of time since the bottle was filled, but also by the changes in color of the liquid. When the liquid is ready for consumption, the cap may be unscrewed and a screw-on spout may be installed, FIG. 6 and #32. The bottles may be stacked directly adjacent to each other, either vertically, FIG. 12, or horizontally, FIG. 13.

### Description and Operation of Alternate Embodiments

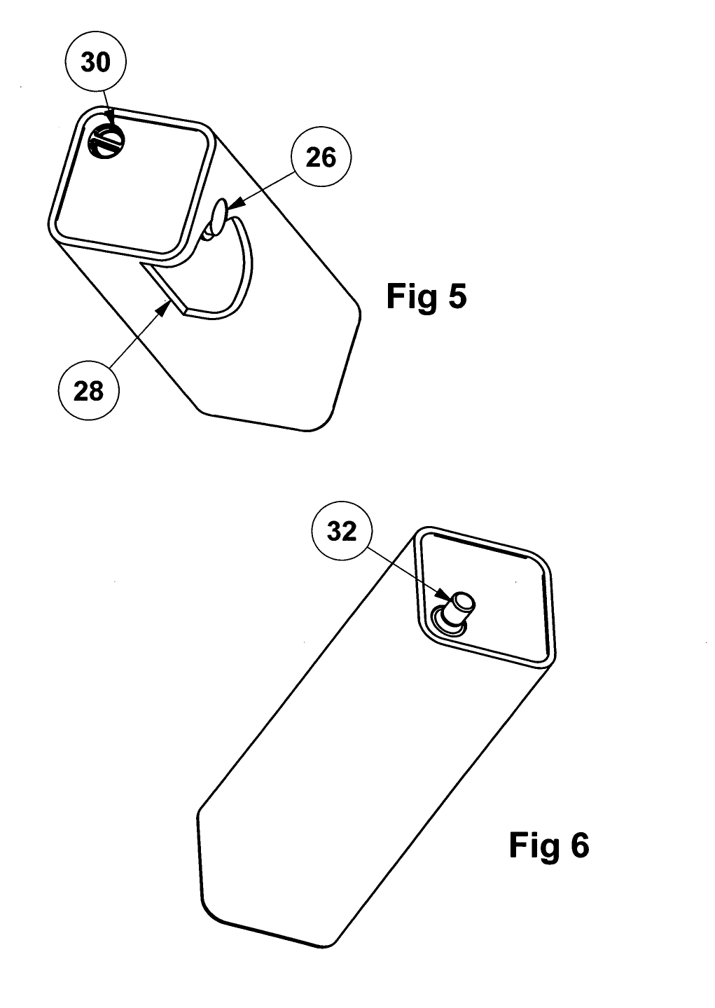

First alternate embodiment of the bottle is one with an embedded see-through button, FIG. 5 #26, on the side of the bottle's body, #26. The screw-on cap for such an embodiment can be opaque, #30. The see through button may be embedded in the top end piece adjacent to the screwed-on cap, as another embodiment.

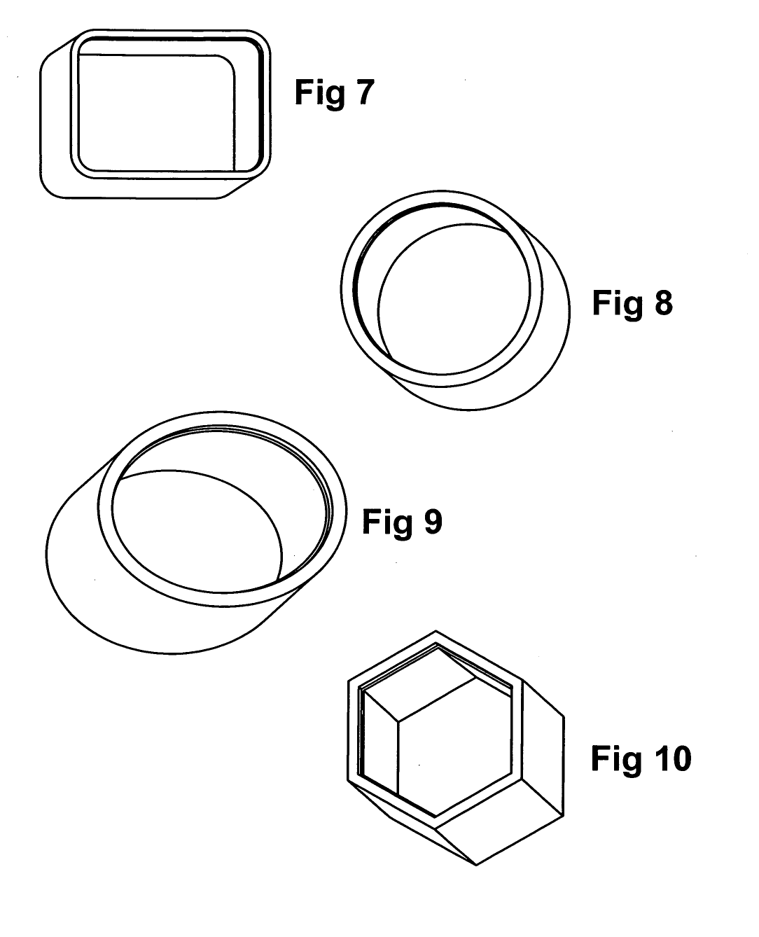

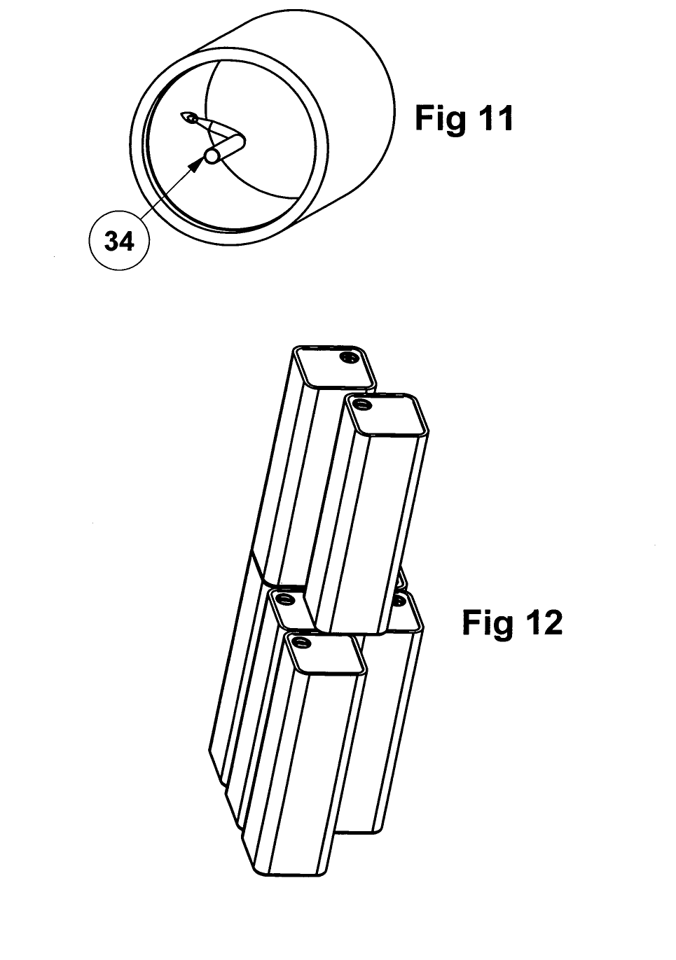

Other embodiments refer to the shape of the body as being rectangle FIG. 7, circle FIG. 8, ellipse FIG. 9, and hexagon FIG. 10.

Yet another embodiment is with reference to the body of the bottle as being made of multiple pieces, FIG. 14.

### CONCLUSIONS, RAMIFICATIONS, AND SCOPE

The invention presented here for a wooden bottle with treated interior suitable for aging spirits, need not be limited to flame treatment and spirits. There will be other forms of treatment for other types of liquids and solids.

The machinability of wood will give rise to many creative designs.

The byproducts of machining wood, such as chips and sawdust are usable elsewhere and hence the invention is environmentally friendly.

I claim:

1. A wooden bottle comprising:
A. hollowed wooden body with integral base with sides and open end,
B. a cover to close said open end, and
C. a filler cap in said cover,
whereby, said bottle can be marketed at retail stores.

2. The bottle of claim 1 wherein:
the interior surfaces of said bottle are treated with heat, whereby said bottle can be filled with liquor for aging said liquor.

3. The bottle of claim 2 wherein:
said cap is made of transparent material,
whereby aging of said liquor can be observed.

4. The bottle of claim 2 wherein:
a side wall of said bottle is embedded with a button of transparent material,
whereby the aging of said liquor can be observed through said button.

5. The bottle of claim 2 whose body is shaped square.

6. The bottle of claim 2 whose body is shaped circular.

7. The bottle of claim 2 whose body is shaped rectangular.

8. The bottle of claim 2 whose body is pentagon shaped.

9. The bottle of claim 2 whose body is hexagon shaped.

10. The bottle of claim 2 whose body is ellipse shaped.

11. A wooden bottle comprising:
A. individual pieces to form the sides and bottom of said bottle,
B. a cover to close said bottle's open end, and
C. a filler cap in said cover,
whereby, said bottle can be marketed at retail stores.

12. The bottle of claim 11 wherein:
the interior surfaces of said bottle are treated with heat, whereby said bottle can be filled with liquor for aging said liquor.

13. The bottle of claim 12 wherein:
said cap is made of transparent material,
whereby aging of said liquor can be observed.

14. The bottle of claim 12 wherein:
a side wall of said bottle is embedded with a button of transparent material,
whereby the aging of said liquor can be observed through said button.
